(19) United States
(12) Patent Application Publication
(10) Pub. No.: US 2010/0284721 A1
(43) Pub. Date: Nov. 11, 2010

(54) IMAGE FORMING SYSTEM AND POST PROCESSING APPARATUS

(75) Inventor: Shoichi NAKAMURA, Tokyo (JP)

Correspondence Address: FRISHAUF, HOLTZ, GOODMAN & CHICK, P.C., 16th Floor, 220 Fifth Avenue, New York, NY, 10001-7708, US

(73) Assignee: Konica Minolta Business Technologies, Inc., Tokyo (JP)

(21) Appl. No.: 12/772,344

(22) Filed: May 3, 2010

(30) Foreign Application Priority Data
May 11, 2009 (JP) JP2009-114328

(51) Int. Cl. G03G 15/00

(52) U.S. Cl. 399/407

(57) ABSTRACT

Disclosed is an image forming system that is capable of performing an image forming operation in a post division processing mode and an insertion paper-sheet processing mode. The system includes an image forming section, a post processing section, an information establishing section to establish post processing information in regard to the post processing to be applied to a subset and a controlling section to control processing operations to be conducted in the post processing section. When both the post division processing mode and the insertion paper-sheet processing mode are established, the information establishing section make it possible to establish independent post processing information in regard to the independent subset of the insertion paper sheet. Further, based on the independent post processing information, the controlling section controls the post processing section, so that the plurality of subsets, divided from the main pages, and the independent subset are processed, respectively and separately.

This application is based on Japanese Patent Application NO. 2009-114328 filed on May 11, 2009, with Japan Patent Office, the entire content of which is hereby incorporated by reference.

### BACKGROUND OF THE INVENTION

The present invention relates to an image forming system, constituted by an image forming apparatus and a post processing apparatus, and a post processing apparatus coupled to an image forming apparatus as its operating mode, and specifically relates to a combination of an image forming apparatus and a post processing apparatus, which is operable in a post division processing mode or an insertion paper-sheet processing mode.

In an image processing system constituted by combining an image forming apparatus and a post processing apparatus with each other, the post processing apparatus performs various kinds of post processing operations, such as a stapling operation (side stitching), a saddle stitching operation, a shifting operation, a punching operation, etc. Conventionally, the abovementioned post processing operations have been applied to one set of bunch of paper sheets as a whole.

In recent years, them has been proposed such a post division processing mode in which the concerned post processing are applied to divided bunches of paper sheets (for instance, set forth in Tokkai 2004-51232 and Tokkai 2004-163908 (both are Japanese Patent Application Laid-Open Publications)). Concretely speaking, in the post division processing mode, one set bunch of paper sheets constituting a whole document is divided into plural bunches of paper sheets, so as to separately and respectively apply post processing operations, such as a stapling operation, etc., to each of the plural bunches of paper sheets. In this connection, Tokkai 2004-51232 and Tokkai 2004-163908 set forth a method in which one set bunch of document paper sheets is divided into plural bunches of document paper sheets, by separately reading the divided bunches of document paper sheets, or by inserting special delimiting paper sheets into between the divided bunches of document paper sheets.

Further, Tokkai 2006-182561 (Japanese Patent Application Laid-Open Publication) sets forth such a post division processing in the mixture mode that makes it possible to establish a determination of whether or not the post processing should be applied to a specific one of the divided bunches of paper sheets.

On the other hand, a certain image forming system is provided with the insertion paper-sheet processing mode in which an insertion paper sheet is inserted at a position before or after of the paper sheet, on which an image is formed, or between the image-formed paper sheets. The insertion paper-sheet processing mode is employed in such a case that plural paper sheets, which are different from each other in thickness and/or color, are inserted into the bunch of paper sheets to be image-formed so as to make them serve as front and rear cover sheets, or a white paper sheet is inserted into the bunch of paper sheets to be image-formed so as to make them serve as a middle compartment paper sheet.

Tokkai 2006-56669 (Japanese Patent Application Laid-Open Publication) sets forth an image forming system provided with the insertion paper-sheet processing mode and the post processing mode in which it is determined whether or not an actual burden of post processing exceeds the processing capacity of the post processing section, provided in the apparatus, from the thickness of each paper sheet onto which contents of the main document is to be printed, the number of paper sheets and the thickness of insertion paper sheet, so as to deactivates the post processing section when determining that the actual burden of post processing exceeds the processing capacity of the post processing section.

### SUMMARY OF THE INVENTION

The present invention relates to the image forming system and the post processing apparatus, both of which can be operated in either the post division processing mode or the insertion paper-sheet processing mode. Herein, the terminology to be employed in the present specification will be detailed in the following. In the present invention, a single batch of printing operations to be performed on the basis of consecutive image data is called a “job”. The “job” is defined as an instruction command for conducting image forming operations to create a plurality of copies based on document data representing a plural number of document paper sheets, so that a plurality of print products are produced on the basis of the instruction command above-defined. A batch of each of the created copies is called a “set”. In other words, one “set” is defined as a single copy product corresponding to document image data representing a single document. Further, in the post division processing mode, one “set” is divided into a plurality of groups, and each of the divided groups is defined as a “subset”.

In the insertion paper-sheet processing mode, each of a front cover sheet, a rear cover sheet and an insertion paper sheet to be inserted into between main pages is defined as an “insertion paper sheet” as the general term of them. Further, a body portion to be image-formed on the basis of image data is defined as “main pages”. Although the “main pages” are divided into a plurality of subsets, when the insertion paper sheet, to be inserted before or after the main pages, or at a position between main pages, is independently established, the concerned insertion paper sheet is handled as a separate subset.

As described in the “BACKGROUND OF THE INVENTION” aforementioned, well known is not only the post division processing mode and the insertion paper-sheet processing mode, but also the image forming system provided with both of the modes. In conventional apparatuses, however, when the post division processing mode and the insertion paper-sheet processing mode are selected at a same time, the post processing is applied to the insertion paper sheet in conjunction with the subset located before or after the insertion paper sheet concerned.

However, there has been such a needs that the post processing to be applied to the insertion paper sheet is made to differ from that to be applied to the main pages. Accordingly, the conventional practice that the post processing, which is the same as that to be applied the main pages, is also applied to the insertion paper sheet has been considerably limited the selecting optional range of the user. For instance, when the user wishes to insert a separate paper sheet, instead of the insertion paper sheet currently inserted, at the same position later on, if the current insertion paper sheet is stapled in conjunction with the main pages, it will be impossible to insert the separate paper sheet at the same position.

An aspect of the present invention is described as follow.

(1) An image forming system that is capable of performing an image forming operation in a post division processing mode, in which one set of main pages constituted by a plurality of paper sheets is divided into a plurality of subsets so as to apply post processing to the plurality of subsets, and an insertion paper-sheet processing mode, in which an insertion paper sheet is inserted into between a pair of main pages located at a predetermined inserting position, the image forming system comprises: a paper sheet feeding section which feeds a paper sheet; an image forming section to form an image onto the paper sheet; an insertion paper sheet feeding section which feeds an insertion paper sheet; a post processing section which applies the post processing to a bunch of paper sheets; an information establishing section which establishes post processing information in regard to the post processing to be applied to a subset; and a controlling section which controls processing operations to be conducted in the post processing section; wherein, when both the post division processing mode and the insertion paper-sheet processing mode are established, the information establishing section regards the insertion paper sheet as an independent subset, being independent from the plurality of subsets divided from the main pages, so as to make it possible to establish independent post processing information in regard to the independent subset of the insertion paper sheet and wherein, based on the independent post processing information in regard to the independent subset of the insertion paper sheet, the controlling section controls the processing operations to be conducted in the post processing section, so that the plurality of subsets, divided from the main pages, and the independent subset of the insertion paper sheet, being independent from the plurality of subsets, are processed, respectively and separately.

Further, another aspect of the present invention is described as follow.

(2) A post processing apparatus that is coupled to an image forming apparatus so as to make it possible to be operated in a post division processing mode, in which one set of main pages constituted by a plurality of paper sheets is divided into a plurality of subsets so as to apply post processing to the plurality of subsets, and an insertion paper-sheet processing mode, in which an insertion paper sheet is inserted into between a pair of main pages located at a predetermined inserting position, the post processing apparatus comprises: a paper sheet stacker which stacks paper sheets thereon, so as to form a bunch of paper sheets; a post processing section which applies the post processing to the bunch of paper sheets stacked on the paper sheet stacker, and a controlling section which controls processing operations to be conducted in the post processing section; wherein, when both the post division processing mode and the insertion paper-sheet processing mode are established, and when the controlling section receives such post processing information that represents an instruction for regarding the insertion paper sheet as an independent subset, being independent from the plurality of subsets divided from the main pages, and another instruction for applying the post processing to the independent subset of the insertion paper sheet or not, the controlling section controls the processing operations to be conducted in the post processing section, based on the post processing information, so as to collectively stack the paper sheets onto the paper sheet stacker independently from previous and following main pages, and to apply the post processing to the bunch of paper sheets stacked onto the paper sheet stacker.

In addition to the above, further details of the present invention are described as follows.

(1-1) The independent post processing information to be established by the information establishing section includes fast information representing the predetermined inserting position, second information representing an instruction for making the post processing to be applied to the insertion paper sheet same as that to be applied to a paper sheet just before the insertion paper sheet or same as that to be applied to a following main page, and third information representing an instruction for applying the post processing to the insertion paper sheet regarded as an independent subset or not.
(1-2) The independent post processing information to be established by the information establishing section is inputted from an operating panel of the image forming section or inputted from a screen displayed by executing a printer driver installed in a computer.
(1-3) The post processing includes at least one of a staple processing, a fold processing and a shift processing.
(1-4) Other than the insertion paper sheet to be inserted into between the pair of main pages located at the predetermined inserting position, at least any one of a front cover sheet and a rear cover sheet also serves as another kind of insertion paper sheet.
(2-1) The post processing information includes first information representing the predetermined inserting position, second information representing an instruction for making the post processing to be applied to the insertion paper sheet same as that to be applied to a paper sheet just before the insertion paper sheet or same as that to be applied to a following main page, and third information representing an instruction for applying the post processing to the insertion paper sheet regarded as an independent subset or not.
(2-2) The post processing information is inputted from an operating panel of the image forming section or inputted from a screen displayed by executing a printer driver installed in a computer, and then, transmitted to the postprocessing apparatus.
(2-3) When it is established that the insertion paper sheet is not regarded as the independent subset being independent from the previous and following main pages, the controlling section regards the insertion paper sheet same as the previous and following main pages and controls the processing operations to be conducted in the post processing section, so as to stack the insertion paper sheet onto the paper sheet stacker as a same subset of the previous and following main pages, and to apply the post processing same as that to be applied to the main pages.
(2-4) the post processing includes at least one of a staple processing, a fold processing and a shift processing.
(2-5) Other than the insertion paper sheet to be inserted into between the pair of main pages located at the predetermined inserting position, at least any one of a front cover sheet and a rear cover sheet also serves as another kind of insertion paper sheet.
(2-6) The insertion paper sheet is supplied from a paper sheet feeding section of the image forming apparatus.
(2-7) the insertion paper sheet is supplied from an exclusive paper-sheet feeding section, which is provided in the post processing apparatus to be exclusively used for the insertion paper sheet.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram indicating an overall configuration of an image forming system embodied in the present invention;

FIG. 2 shows a block diagram indicating a configuration for controlling an image forming system embodied in the present invention;

FIG. 3a, FIG. 3b and FIG. 3c show schematic diagrams indicating conceptual arrangements of subsets divided in a post division processing mode;

FIG. 4 shows a schematic diagram indicating a fundamental setting screen to be displayed by executing a printer driver installed in a computer;

FIG. 5 shows a schematic diagram indicating a cover-sheet insertion paper-sheet setting screen to be displayed by executing a printer driver installed in a computer;

FIG. 6 shows a schematic diagram indicating a list edition setting screen to be displayed by executing a printer driver installed in a computer;

FIG. 7 shows a schematic diagram indicating a table in which contents of data to be stored in a compressed-data storage are indicated;

FIG. 8 shows a flowchart indicating an overall process of a post processing determination processing to be conducted by a printer control section;

FIG. 9 shows a flowchart indicating a subroutine SA of a post processing determination processing to be conducted by a printer control section;

FIG. 10 shows a flowchart indicating a subroutine SB of a post processing determination processing to be conducted by a printer control section;

FIG. 11 shows a flowchart indicating a subroutine SC of a post processing determination processing to be conducted by a printer control section; and

FIG. 12 shows a flowchart indicating a procedure to be conducted in a FNS control section for controlling post processing.

### DETAILED DESCRIPTION OF THE PREFERRED EMBODIMENT

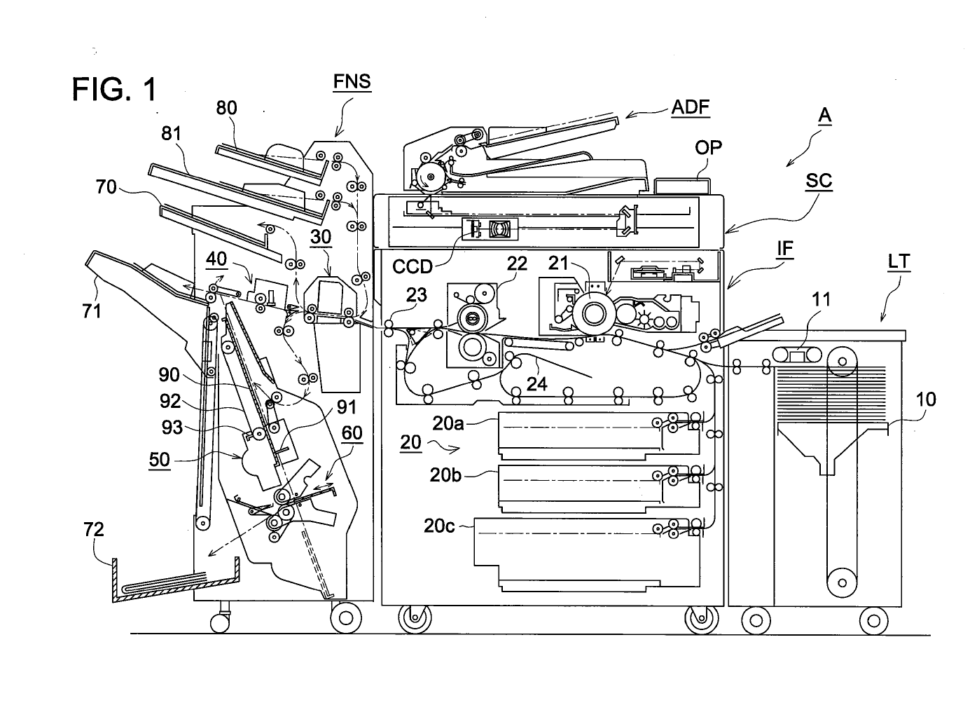

Referring to a schematic diagram shown in FIG. 1, an overall configuration of the image forming system embodied in the present invention will be detailed in the following. FIG. 1 shows the schematic diagram indicating the overall configuration of the image forming system constituted by an image forming apparatus A, a mass capacity paper-sheet feeding apparatus LT and a post processing apparatus FNS.

As shown in FIG. 1, the mass capacity paper-sheet feeding apparatus LT is provided with a paper sheet stacking plate 10, which elevates while stacking a mass number of paper sheets thereon, so that an air absorbing paper-sheet feeding device 11 picks up a paper sheet located at an uppermost position on the paper sheet stacking plate 10 one by one, so as to feed the picked-up paper sheet into the paper sheet feeding path of the image forming apparatus A.

The image forming apparatus A is constituted by an automatic document feeder ADF, an image reading section SC, both of which are disposed in the upper space, and an image forming section IF, which is located in the lower space. An operating panel OP is disposed on the upper surface of the image reading section SC. The operating panel OP includes a touch panel overlapping on a display screen of a LCD (Liquid Crystal Display), so as to make it possible for the user to input various kinds of settings and operations by depressing the touch panel while viewing contents displayed on the display screen.

In the image forming section IF, numeral 20 indicates a paper sheet accommodating section, which accommodates paper sheets therein, and which is provided with a plurality of paper sheet feeding trays 20a, 20a, 20c. A paper sheet is fed from either the paper sheet stacking plate 10 of the mass capacity paper-sheet feeding apparatus LT, or any one of the paper sheet feeding trays 20a, 20a, 20c. Then, a toner image, formed on a circumferential surface of a photoreceptor drum 21 through the electro-photographic image forming process, is transferred onto the paper sheet, and the transferred toner image is fixed onto the paper sheet by a fixing device 22. Successively, the paper sheet having the fixed toner image is ejected outside the apparatus through the ejection opening by a pair of ejection rollers 23.

In the case of the duplex image copying operation, the paper sheet having the fixed toner image is conveyed downward at a front side of the pair of ejection rollers 23, so as to return it to the transferring position through a conveyance path 24 to form another image onto the reverse side of the paper sheet.

The post processing apparatus FNS is provided with four post processing units, including a punch processing section 30, a shift processing section 40, a staple processing section 50 and a fold processing section 60, and further provided with three ejection trays, including a fixed ejection tray 70, an up-down moving ejection tray 71 and a lower section ejection tray 72. Further, an insertion paper sheet tray 80 and an insertion paper sheet tray 81 are disposed at an upper section of the post processing apparatus FNS as two stage trays.

Either the paper sheet ejected from the image forming apparatus A, or an insertion paper sheet conveyed from any one of the insertion paper sheet trays 80, 81, is further conveyed by the conveyance path that merges with the input opening of the post processing apparatus FNS, so that the paper sheet or the insertion paper sheet, concerned, passes through the punch processing section 30. After that, a conveyance path switching member, disposed downstream the punch processing section 30, switches the conveyance path of the concerned paper sheet to any one of the upper elevating path through which the paper sheet is ejected onto the fixed ejection tray 70, the other path through which the paper sheet passes through the shift processing section 40 and is ejected onto the up-down moving ejection tray 71, and the lower descending path through which the paper sheet is conveyed downward and stacked onto a paper sheet stacker 90.

The paper sheet stacker 90 is provided with a stopper 91, so that, after the concerned paper sheet to be ejected onto the paper sheet stacker 90 has proceeded in a diagonal upward direction along the paper sheet stacking surface, the concerned paper sheet slides downward on the paper sheet stacking surface and is stopped by the stopper 91. Then, at the time when a predetermined number of paper sheets have been stacked on the paper sheet stacker 90, the staple processing section 50 staples the bunch of paper sheets stacked.

At the time when the staple processing is completed, the stopper 91 elevates to push up the bunch of paper sheets stapled, and a pushing up member 93 attached to a belt member 92, which is threaded along the paper sheet stacker 90, further pushes up the bunch of paper sheets stapled, so as to eject it onto the up-down moving ejection tray 71.

When an application of the fold processing is also instructed as the post processing, the bunch of paper sheets stacked onto the paper sheet stacker 90 proceeds into the fold processing section 60, constituted by folding rollers, a folding plate, etc., so as to fold it two or three, and the bunch of paper sheets folded is ejected onto the lower section ejection tray 72. Further, in the case of saddle stitching, the bunch of paper sheets is folded along the saddle stitching line after its saddle stitching is completed. Since the abovementioned configurations and operations of the image forming system are well known by a person having ordinary skill in the art, the detailed explanation for it will be omitted in the following.

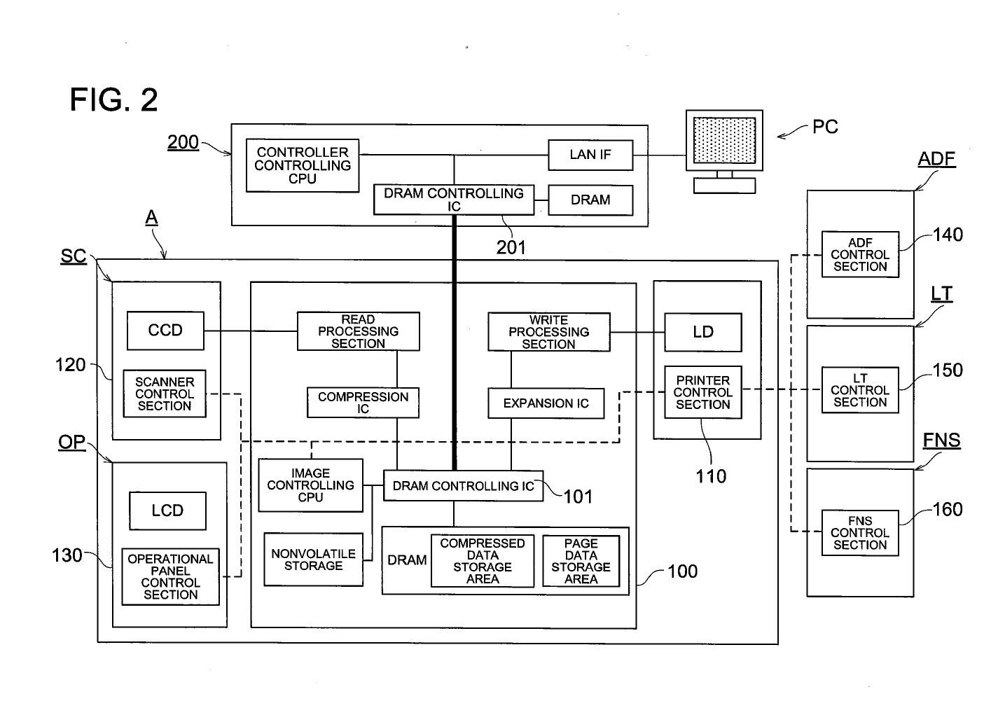

FIG. 2 shows a block diagram indicating a configuration for controlling the image forming system embodied in the present invention. In FIG. 2, the operational blocks for processing image data are spotlighted, while the configuration constituted by the other operational blocks for conducting the sequential control operations is briefly indicated.

As shown in FIG. 2, the image forming apparatus A is provided with a image processing control section 100, a printer control section 110, a scanner control section 120 and an operational panel control section 130, each of which is coupled to an ADF control section 140, an LT control section 150 and an FNS control section 160, which are to be coupled to the image forming apparatus A proper, through a serial communication line indicated by broken lines. In this connection, although the CPU (image data controlling CPU (Central Processing Unit)) and the storage for storing programs (nonvolatile storage) are indicated only in the image processing control section 100, each of the other control sections abovementioned is also provided with a CPU and a storage (not shown in the drawings), so as to conduct the sequential control operations in conjunction with the other CPUs and the other storages through the serial communication line.

Further, in FIG. 2, numeral 200 indicates a printer controller to be coupled to the image forming apparatus A, and is coupled to an external personal computer PC through a LAN (Local Area Network) so as to receive print data sent from an external personal computer PC and applies various kinds of image processing to the received print data. It is applicable that the printer controller 200 is either attached to or mounted into the image forming apparatus A proper.

Since the print data to be created by the personal computer PC is written in a specific one of various kinds of Page Description Languages, such as a PS (PostScript), a PCL (Print Command Language), etc., the printer controller 200 is provided with such a function that parses the print data so as to convert the concerned print data to bitmap data. In addition to the above, the printer controller 200 also implements a processing for adjusting the image, such as a screen processing, etc., a conversion processing for converting character data to those complying with an internally provided font, etc. Under the controlling operations conducted by a controller controlling CPU, a DRAM (Dynamic Random Access Memory) controlling IC (Integrated Circuit) 201 implements the above-mentioned processing while using a DRAM as a working memory.

The DRAM controlling IC 201 of the printer controller 200 is coupled to a DRAM controlling IC 101 of the image processing control section 100 through a PCI (Peripheral Component Interconnect) bus indicated by the bold solid line, so as to transfer the converted image data and various kinds of information, established by the printer driver of the personal computer PC, to the image processing control section 100.

Under the controlling operations conducted by the image data controlling CPU of the image processing control section 100, the DRAM controlling IC 101 temporarily stores the received image data into a page memory serving as a buffer memory, and then, sends the image data to the compression IC to apply an image data compression processing to the image data concerned, so as to store the compressed image data into a compressed data storage area in the DRAM.

According to the controlling sequence, the compressed image data is transmitted to an expansion IC to expand the compressed image data, so that the expanded image data is further processed in a write processing section to drive a laser diode LD based on the image data.

On the other hand, document image data, read from the document by a CCD (Charge Coupled Device) sensor of the image reading section SC, is stored into a compressed data storage area in a DRAM, provided in the image processing control section 100, through a read processing section and a compression IC, as well as the above, and then, through the same processes as those for the print data, the expanded document image data is further processed in the write processing section to drive the laser diode LD based on the document image data. Various kinds of setting information, to be employed at the time when the image reading section SC reads the document, are inputted from the operating panel OP and transferred from the operational panel control section 130 to the sections concerned. In this connection, the thin solid lines indicate the data transferring lines, through which various kinds of structural parts and circuits are coupled to each other.

As described in the foregoing, the print image data sent from the personal computer PC, or the document image data read from the document is processed by applying various kinds of processing, compressed and expanded, and finally, an image based on the image data concerned is written onto the circumferential surface of the photoreceptor drum 21 by the laser diode LD. Further, associating with the sequential control information, the various kinds of setting information inputted from the personal computer PC and/or the operating panel OP are transmitted to each of the control sections provided in each of sections concerned.

The setting information in regard to the post processing embodied in the present invention, is written in a unit of a job, a set or a subset. As detailed later, the image processing control section 100 parses the setting information for every paper sheet and transmits it to the FNS control section 160 so as to employ it for the post processing control operations.

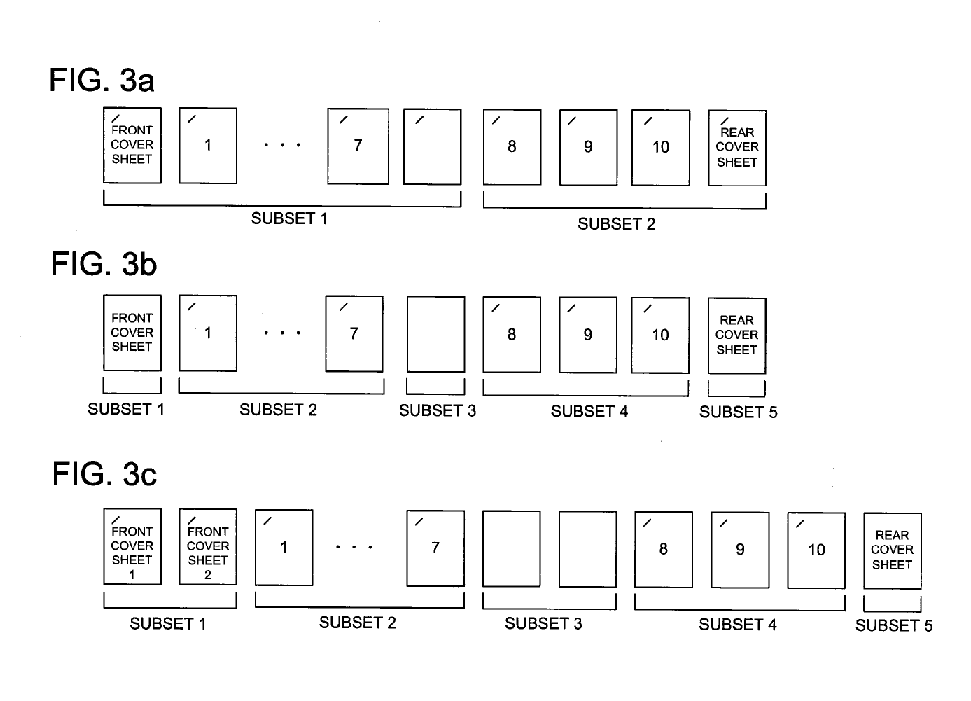

According to the present invention, when both the post division processing mode and the insertion paper-sheet processing mode are established, the system embodied in the present invention makes it possible to independently establish the post processing settings for the insertion paper-sheet processing mode as the subset Referring to FIG. 3a, FIG. 3b and FIG. 3c, the abovementioned concept will be detailed in the following.

FIG. 3a shows a schematic diagram indicating a state of outputted paper sheets in such a case that both the post division processing mode and the insertion paper-sheet processing mode are established in the conventional apparatus. Concretely speaking, indicated in FIG. 3a is the state of the outputted paper sheets in which a front cover sheet is placed in front of divided main pages 1 through 7 and a white insertion paper sheet is inserted at a position next to the main page 7, and further, a rear cover sheet is placed at a position next to divided main pages 8 through 10, and still further, the staple processing for stapling a left corner of the main pages is established as one of the post processing. In the conventional apparatus, the post processing to be applied to each of the front cover sheet, the rear cover sheet and the white insertion paper sheet are the same as those to be applied to the main page located before or after each of them concerned. In other words, staple processing is applied to the front cover sheet, the rear cover sheet and the white insertion paper sheet by regarding that the front cover sheet is included in the post processing grope for the divided main pages 1 through 7, the white insertion paper sheet is included in the post processing grope for the subset 1 and the rear cover sheet is included in the other post processing grope for the subset 2, including the divided main pages 8 through 10, respectively.

With respect to the main pages and the insertion paper sheets, both being same as the abovementioned, FIG. 3b shows another schematic diagram indicating another state of outputted paper sheets in such a case that the post processing for the insertion paper sheets are established independently from the main pages, namely, the front cover sheet is established as subset 1, a group of the divided main pages 1 through 7 is established as subset 2, the white insertion paper sheet is established as subset 3 and a group of the divided main pages 8 through 10 is established as subset 4, so that subsets 1, 3 and 5 are independent from subset 2 and 4 of the main pages, and the staple processing is not applied to subsets 1, 3 and 5. In this connection, it is needless to say that it is also possible for the apparatus, embodied in the present invention, to establish the settings for the post processing, being same as those to be established by the conventional apparatus.

Other than the above, as shown in FIG. 3c, it is also possible to independently established the contents of the post processing to be applied to each of subsets, for instance, in such a manner that subset 1 includes a plurality of front cover sheets and the staple processing is applied to subset 1, subset 3 includes a plurality of white insertion paper sheets but the staple processing is not applied to subset 3, and the staple processing is not applied to subset 5 since subset 5 includes only a single rear cover sheet.

For instance, according to the example shown in FIG. 3c, it becomes possible that a paper sheet, on which a color image was printed separately, is placed on the insertion paper sheet tray 80 (insertion paper sheet tray 1) of the post processing apparatus FNS in advance, so as to insert the concerned paper sheet into between subset 2 and subset 4. In this connection, hereinafter, the meaning of “white” included in the term of “white insertion paper sheet” is to print no image on the paper sheet concerned. Accordingly, other than the white paper sheet in the literature, either a color paper sheet, or a paper sheet on which an image is separately printed, is also defined as the “white insertion paper sheet” in the present specification. For instance, when the post processing to be applied to the white insertion paper sheets of subset 3 is established as “absence of stapling”, it becomes possible to insert a special type paper sheet, such as a paper sheet having a postcard size, etc., into between the plural paper sheets of subset 3, after its ejecting operation is completed.

According to the embodiment of the present invention, described in the foregoing, since the image forming system is so constituted that the post processing to be applied to the insertion paper sheet can be established independently from that to be applied to the main pages, as an independent subset, it becomes possible to widen the flexibility of the user's selecting operation and the usability of the user.

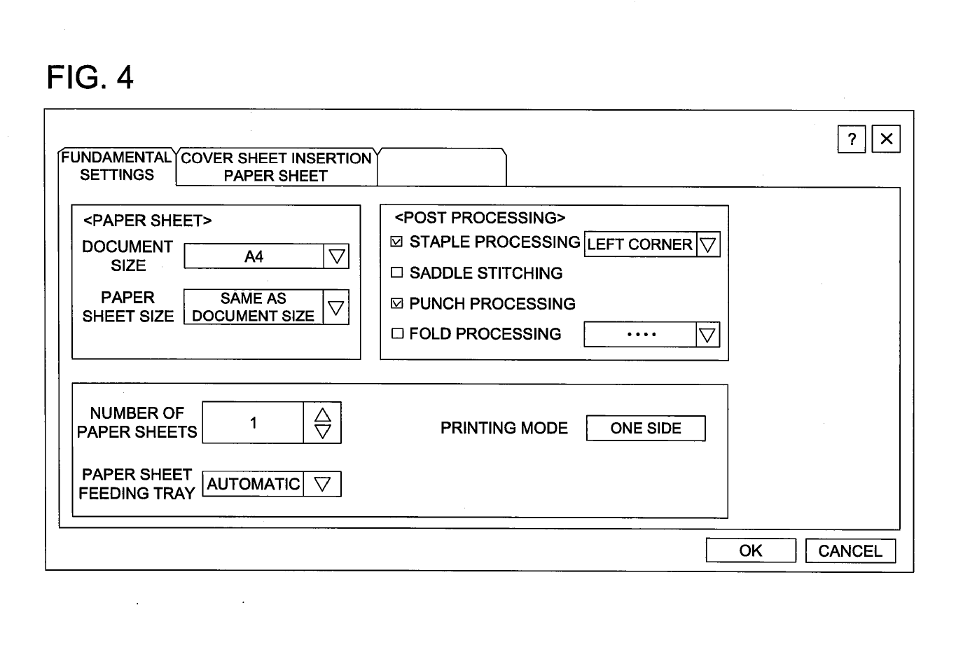

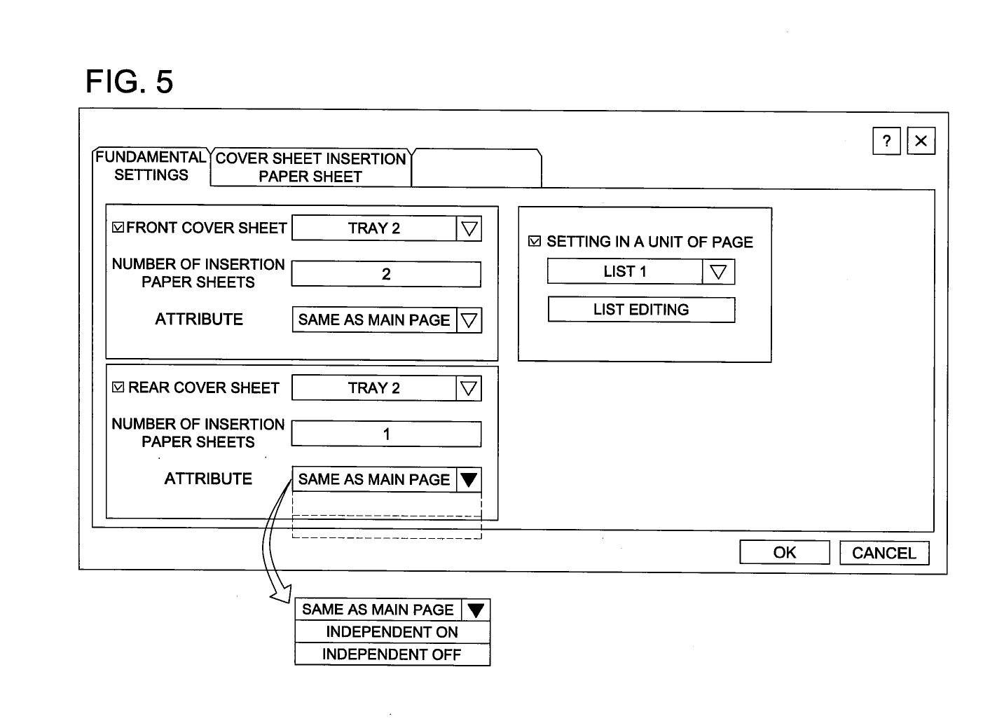

FIGS. 4 through 6 show schematic diagrams indicating various kinds of screens to be displayed when various kinds of settings are established by using the printer driver of the personal computer PC. The screens shown in FIG. 4 and FIG. 5 are displayed by clicking the tubs of “FUNDAMENTAL SETTING” and “COVER SHEET INSERTION PAPER SHEET”, respectively. The screen shown in FIG. 4 is displayed by selecting “SETTING IN UNIT OF PAGE” and by clicking the “LIST EDITING”. In this connection, when the document is read by the automatic document feeder ADF, the same operations are conducted from the operating panel OP of the image forming apparatus A.

The fundamental settings, such as a size of the paper sheet, a number of printed copies, a paper sheet feeding tray to be used, a print type, etc., and the post processing (finishing) settings are established from the tub of “FUNDAMENTAL SETTING” shown in FIG. 4. The items, included within the area surrounded by the rectangular line located at a right-upper section of the screen, are the post processing (finishing) settings, from which the user can establish the desired post processing, such as a staple processing, a saddle stitching, a punch processing and a fold processing. Further, with respect to the staple processing, the pull down menu indicates that the setting of the “LEFT CORNER” position is selected currently, and other than the above, it is possible for the user to select any one of a “RIGHT CORNER” position, a “LEFT TWO POSITIONS”, etc. The above-settings may vary depending on the stapling function to be mounted. As well as the above, with respect to the fold processing, by using the pull down menu, it is possible for the user to select any one of a “MIDDLE FOLDING”, a “FOLDING THREE” and a “BUNCH FOLDING THREE”.

The settings in regard to the insertion paper sheet, such as a front cover sheet, a rear cover sheet and an intermediate insertion paper sheet, are established from the tub of “COVER SHEET INSERTION PAPER SHEET” shown in FIG. 5. When inserting the front cover sheet and the rear cover sheet, the user checks the checkbox located at a left side of the displayed frame, and then, establishes the settings in regard to the tray in which the cover paper sheets to be inserted are currently accommodated, the number of paper sheets to be inserted and the attributes. With respect to the setting of the attributes, the user selects any one of “SAME AS MAIN PAGE”, “INDEPENDENT ON” and “INDEPENDENT OFF”, which are indicated in the pull down menu indicated below by the white bold arrow shown in FIG. 5.

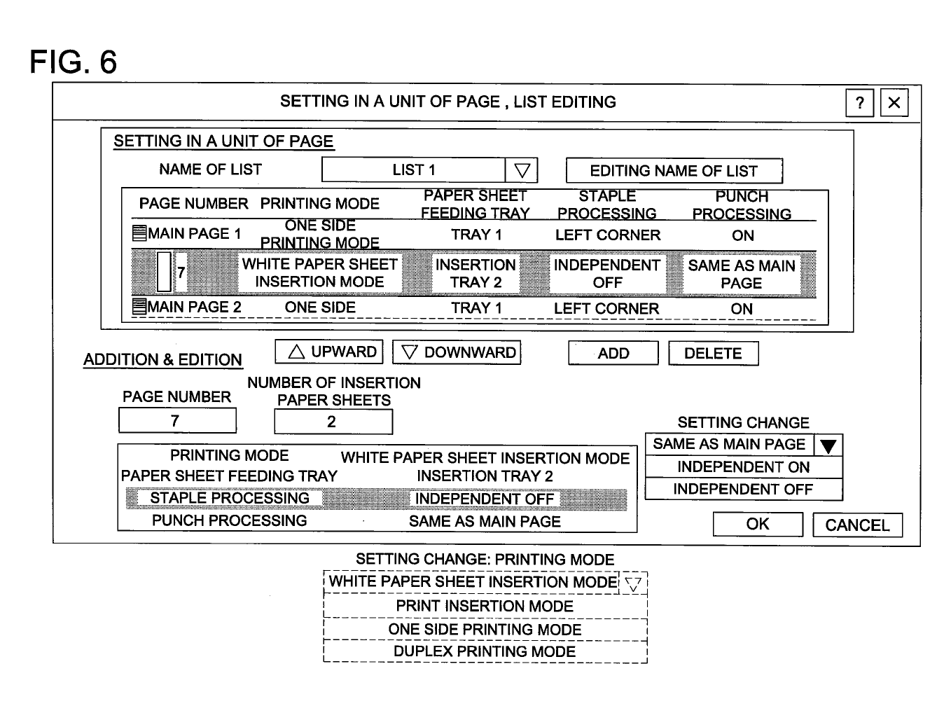

With respect to the settings of the intermediate insertion paper sheet, the user selects “SETTING IN UNIT OF PAGE”, to select a desired list from the lists established in advance, and then, clicks the “LIST EDITING” button. Then, the screen currently displayed will shift to the “LIST EDITING SCREEN” shown in FIG. 6.

In the “LIST EDITING SCREEN”, the user can select any one of plural lists by using the list selecting button located at an uppermost position of the “LIST EDITING SCREEN”. Further, it is possible for the user to change the name of the selected list by depressing the “LIST NAME EDITING” button.

The display window located below the list selecting button serves as such a display window that displays the state of the selected list thereon, in which the names of items, including “PAGE NUMBER”, “PRINTING MODE”, “PAPER SHEET FEEDING TRAY”, “STAPLE PROCESSING” and “PUNCH PROCESSING”, are indicated in the uppermost line of the display window concerned, and the setting statuses respectively corresponding to the abovementioned names of items of each of the divided subsets are indicated in each of the following lines. Among those lines, the shaded line with the symbol “□7” is the currently selected line. In addition, the “ADD” button and the “DELETE” button is displayed under the display window concerned, so as to make it possible to select an operation for either adding the insertion paper sheet, or deleting the insertion paper sheet added in advance. Further, when plural insertion paper sheets are established, it is possible to change the order of them by using the “UPWARD” button and the “DOWNWARD” button.

The area located under the display window serves as a portion for adding and editing the selected subset. The user can input the final page number of the previous main page into the inputting window located below the legend of “PAGE NUMBER” as a position of the insertion paper sheet to be inserted, and the number of insertion paper sheets into the other inputting window located below the legend of “NUMBER OF INSERTION PAPER SHEETS”. For instance, when the page number is 7 and the number of insertion paper sheets is 2, an operation for inserting two insertion paper sheets after the main page 7 is established. Further, the display window located under the above mentioned inputting windows is to be used for changing the each of the items of the selected subset. The user clicks any one of the items displayed within the concerned display window so as to select it (change it to the shaded line), and changes the setting of the item by using the setting change pull down menu. The pull down menu shown in FIG. 6 is displayed at the time when the “STAPLE PROCESSING” is selected, so that the user can designate any one of “SAME AS MAIN PAGE”, “INDEPENDENT ON” and “INDEPENDENT OFF”.

After inputting the settings in regard to each of various kinds of items by using the abovementioned inputting windows and buttons, the user may depress the “OK” button to fix the above-inputted establishment. In this connection, the pull down menu, depicted by the broken rectangular lines indicated in the lower section shown in FIG. 6, indicates options for the various kinds of printing modes, so that the user can select any one of the “WHITE PAPER SHEET INSERTION MODE”, the “PRINT INSERTION MODE”, the “ONE SIDE PRINTING MODE” and the “DUPLEX PRINTING MODE”. Herein, in the “WHITE PAPER SHEET INSERTION MODE”, none of characters are printed onto the insertion paper sheet concerned. Further, in the “PRINT INSERTION MODE”, a page number continued from that of previous main pages is printed on the insertion paper sheet concerned. Still further, either the “ONE SIDE PRINTING MODE” or the “DUPLEX PRINTING MODE” is selected in such a case that the printing mode of the main pages is established as the duplex printing mode, while an image, to be printed onto a final page of previous main pages based on image data concerned, is printed onto the insertion paper sheet to be inserted in either the one side printing mode or the duplex printing mode. For instance, in such a case that, when the main pages are divided into a plurality of chapters and printed in the duplex printing mode, the user wishes to arrange the main pages in such a manner that a top page of a specific chapter, having an even page number, is commenced from a right-side spread page, the user selects the “ONE SIDE PRINTING MODE”. In this case, since the final page of the main pages, inputted into the area of the page number, is printed onto the insertion paper sheet and becomes a blank paper sheet, the top page of the next main pages is commenced from the right-side spread page.

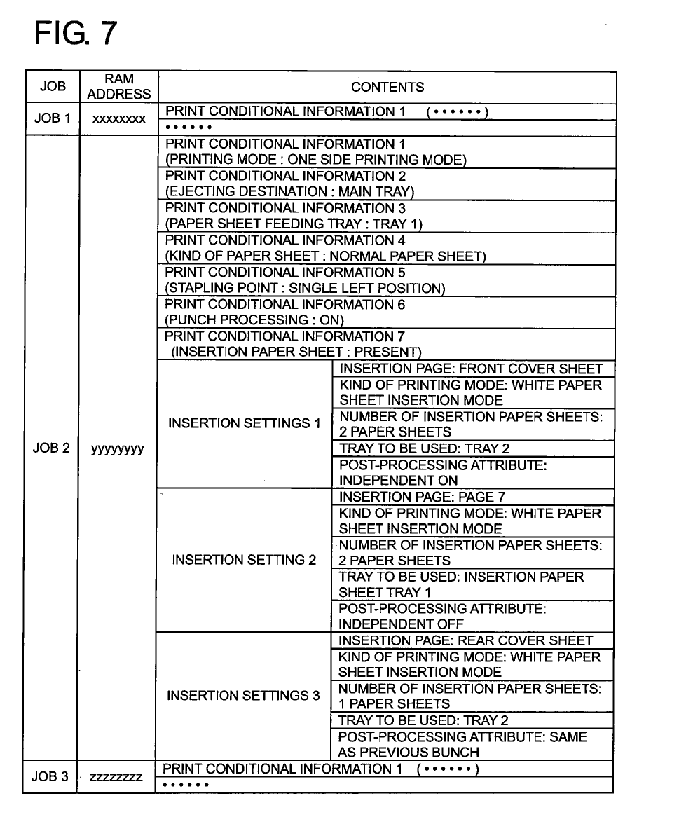

The conditional information, in regard to the insertion paper sheet established as abovementioned, is stored into the compressed data storage, associating with the image data FIG. 7 shows a table in which the contents of data to be stored in the compressed data storage are indicated. As shown in FIG. 7, the table includes addresses of the image data to be stored and the print conditional information. The compressed data storage stores the data to be print-processed for every job, therein, and the job 2, shown in FIG. 7, corresponds to the aforementioned case shown in FIG. 3c.

As indicated in the table shown in FIG. 7, the print conditional information 1 through 7 are established for the job 2. Concretely speaking, the print conditional information 1 indicates the “ONE SIDE PRINTING MODE” selected from the options of the “ONE SIDE PRINTING MODE” and the “DUPLEX PRINTING MODE”. Further, the print conditional information 2 indicates that the main tray (up-down moving ejection tray 71) is designated as the destination of ejecting the print products, the print conditional information 3 indicates that the tray 1 (paper sheet feeding tray 20a) is designated as a paper sheet feeding tray from which the paper sheets for the main pages are to be fed, the print conditional information 4 indicates that the paper sheets accommodated in the tray 1 (paper sheet feeding tray 20a) are normal paper sheets, the print conditional information 5 indicates that the single left position is designated as the stapling point as one of the post processing, and the print conditional information 6 indicates that the punch processing is selected as another one of post processing.

Still further, the print conditional information 7 is related to the insertion paper sheet. In regard to the example shown in FIG. 3c, since the front cover sheets, the intermediate insertion paper sheets and the rear cover sheet are to be inserted into the main pages, three sets of information including insertion settings 1, insertion settings 2 and insertion settings 3, which are respectively correspond to the three kinds of insertion paper sheets abovementioned, are provided in the table. Each of the insertion settings 1-3 includes five settings, such as an “insertion page”, a “kind of printing mode”, a “number of insertion paper sheets”, a “tray to be used” and “post-processing attribute”.

The information of the “insertion page” represents a position at which the insertion paper sheet concerned is to be inserted. Accordingly, since the insertion paper sheets in regard to insertion settings 1 are placed in front of the main pages, the “insertion page” is represented as a “FRONT COVER”. Further, the “insertion page” in regard to insertion settings 2 is represented as a “page 7”, which indicates the page 7 serving as the final page of the subset 2. Further, the “insertion page” in regard to insertion settings 3 is represented as a “rear cover”.

The information of the “kind of printing mode” represents whether or not a page number is to be printed onto the insertion paper sheet concerned, by indicating either the “PRINT INSERTION MODE” or the “WHITE PAPER SHEET INSERTION MODE”. In the present embodiment, the “kind of printing mode” in every insertion settings is represented as the “WHITE PAPER SHEET INSERTION MODE”. The setting for printing the page number onto the insertion paper sheet is effective when a paper sheet feeding tray of the image forming apparatus A is used as a current tray for the insertion paper sheet concerned. When the insertion paper sheets shown in FIG. 3c is established as the “PRINT INSERTION MODE”, the page numbers of Page 8 and Page 9 are printed onto the two insertion paper sheets, respectively, and the page numbers of main pages 2 are put off by 2 pages, respectively.

The information of the “number of insertion paper sheets” represents a number of insertion paper sheets to be inserted. Although only a single insertion paper sheet can be inserted in the conventional apparatus, according to present invention, it is possible to insert a plural number of insertion paper sheets, which is represented by the “number of insertion paper sheets”. Further, the information of the “tray to be used” represents a tray in which insertion paper sheets concerned are accommodated. In this embodiment, the information of the “tray to be used” indicated in insertion settings 1 and insertion settings 3 represents tray 2. Accordingly, it is possible to accommodate specific paper sheets, for instance, color paper sheets, being different from paper sheets to be accommodated into tray 1 for printing use of the main pages, into tray 2, so as to make them serve as the front and rear cover sheets. On the other hand, the information of the “tray to be used” indicated in insertion settings 2 represents the insertion paper sheet tray 1 (insertion paper sheet tray 80).

The information of the “post-processing attribute” represents a setting of post processing (in the present embodiment, the staple processing), which can be independently established for every subset and can be selected from the options of “INDEPENDENT ON” “INDEPENDENT OFF”, “SAME AS PREVIOUS BUNCH” and “SAME AS FOLLOWING BUNCH”. However, as for the front and mar cover sheets, since only a single main page corresponds to the adjacent main page, it is also possible to established it as “SAME AS MAIN PAGE”, and the setting screen, detailed later, will be established in the same manner. Either “INDEPENDENT ON” or “INDEPENDENT OFF” represents whether or not the post processing is applied to the concerned subset independently from the adjacent main page. Concretely speaking, the term of “INDEPENDENT” represents a setting of “making the concerned subject independent from the adjacent subject”, while the term of “ON” represents a setting of “applying the post processing” and the term of “OFF” represents a setting of “not applying the post processing”. Each of “SAME AS PREVIOUS BUNCH”, “SAME AS FOLLOWING BUNCH” and “SAME AS MAIN PAGE” represents such a setting that the concerned subset is not made independent from the main pages.

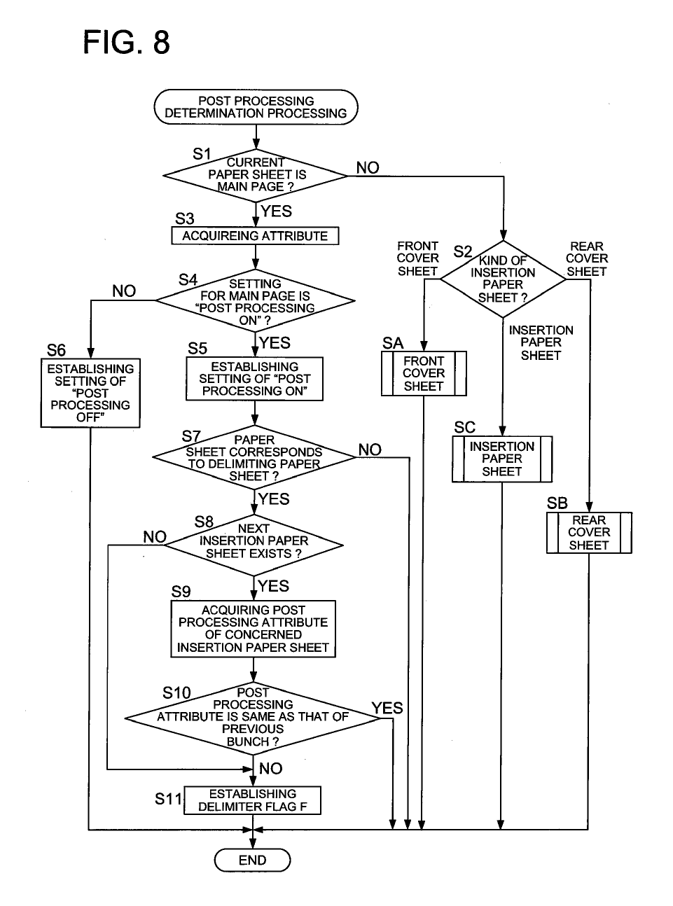

FIGS. 8 through 11 show flowcharts indicating the processes of the post processing determination processing to be conducted by the printer control section 110, and specifically indicating processing flow in which the printer control section 110 parses the print condition information aforementioned so as to established the information to be sent to the FNS control section 160. Other than the above, although the printer control section 110 conducts the sequential controlling operations of the printer section, etc., the explanations for them will be omitted in the following, since those operations are well known by a skilled person in the art. In the following explanations, the subset dividing operation, namely, the operation for attaching the delimiter information for dividing the main pages into plural subsets, will be spotlighted. The FNS control section 160 applies post processing to paper sheets, based on the delimiter information sent from the printer control section 110.

As aforementioned, the information to be received by the printer control section 110 is described in a unit of a job, a set or a subset. However, since each of the print control operation and the post processing control operation is conducted in a unit of one paper sheet, the printer control section 110 parses the conditional information, shown in FIG. 7, for every one of the paper sheets.

FIG. 8 shows a flowchart indicating an overall process of the post processing determination processing to be conducted by the printer control section 110. Initially, in Step S1, the printer control section 110 determines whether a paper sheet to be currently processed is a main page or an insertion paper sheet. When determining that the paper sheet concerned is the insertion paper sheet, in Step S2, the printer control section 110 further determines a kind of insertion paper sheet, so as to proceed to any one of subroutines SA, SB and SC, respectively corresponding to the “front cover sheet”, the “rear cover sheet” and the “insertion paper sheet”.

When determining that the paper sheet concerned is the main page in Step S1, the printer control section 110 acquires its attribute (print conditional information) (Step S3), so as to determine whether or not the setting for the main page is “POST PROCESSING ON” (Step S4), and establishes the setting of either “POST PROCESSING ON” or “POST PROCESSING OFF” (Step S5, Step S6). When establishing the setting of “POST PROCESSING OFF”, the printer control section 110 finalizes the processing for the paper sheet concerned. On the other hand, when establishing the setting of “POST PROCESSING ON”, the printer control section 110 determines whether or not the paper sheet corresponds to the delimiting paper sheet of the subset concerned (Step S7). This decision is made by determining whether or not the current paper sheet is the final page of the subset concerned.

When determining that the current paper sheet is the final page of the subset concerned, the printer control section 110 determines whether or not a next insertion paper sheet exists (Step S8), and acquires the post processing attribute of the insertion paper sheet in Step S9 when determining that the next paper sheet is the insertion paper sheet. Then, the printer control section 110 determines whether or not the post processing attribute of the insertion paper sheet concerned is the same as that of the previous bunch (Step S10), and when determining that the concerned attribute is the same as that of the previous bunch, finalizes the process of this flowchart, since the post processing same as that for the main pages is also applied to the insertion paper sheet concerned. On the other hand, when determining that the concerned attribute is not the same as that of the previous bunch in Step S10), the printer control section 110 establishes the delimiter information (delimiter flag F) in Step S11. The abovementioned delimiter information is sent to the FNS control section 160, so as to serve as an instruction command for applying the post processing to the bunch of paper sheets already stacked onto the paper sheet stacker 90. Even when the next insertion paper sheet does not exist, since the next processing is to be applied to the subset of divided main pages, the printer control section 110 proceeds to Step S11, in order to establish the delimiter information.

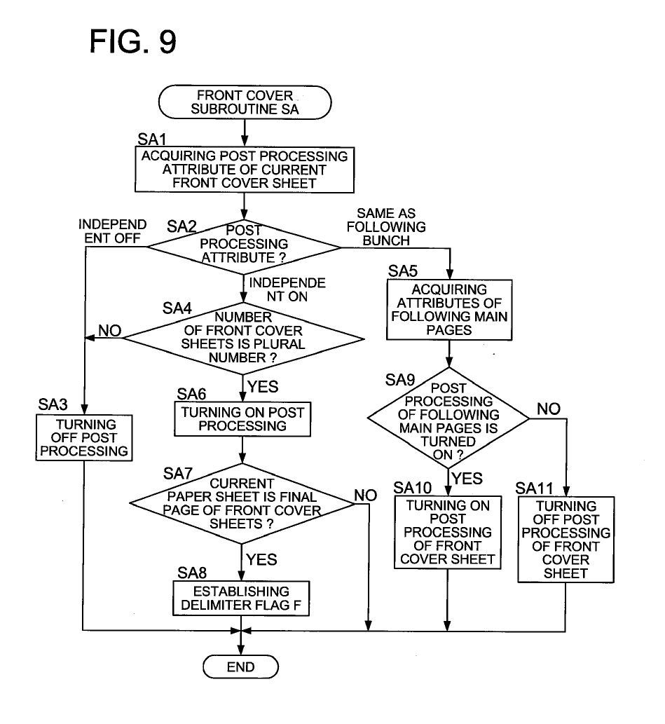

According to the subroutine SA for conducting the post processing determination processing in regard to the front cover sheet, indicated in the flowchart shown in FIG. 9, initially in Step SA1, the printer control section 110 acquires the post processing attribute of the current front cover sheet, and then, proceeds to any one of Step SA3, Step SA4 and Step SA5, corresponding to the above-acquired attribute (Step SA2). When the above-acquired attribute indicates “INDEPENDENT OFF”, since no post processing is applied to this paper sheet, the post processing for this paper sheet is turned OFF in Step SA3.

When the above-acquired attribute indicates “INDEPENDENT ON”, the printer control section 110 determines whether or not a number of front cover sheets is a plural number, from the information of “number of insertion paper sheets” (Step SA4), and when determining that the front cover sheet is a single paper sheet (Step SA4; No), proceeds to Step SA3, so as to turn OFF the post processing. When determining that the number of front cover sheets is a plural number (Step SA4; Yes), the printer control section 110 turns ON the post processing in Step SA6, and in Step SA7, determines whether or not the current paper sheet is the final page of the front cover sheets. When determining that the current paper sheet is the final page, the printer control section 110 establishes the delimiter information (delimiter flag F) in Step SA8, and then, finalizes the processing (END), while when determining that the current paper sheet is not the final page, finalizes the processing as it is without establishing the delimiter information (END).

When the above-acquired attribute indicates “SAME AS FOLLOWING BUNCH” in Step SA2, the printer control section 110 acquires attributes of the following main pages in Step SA5, so as to determine whether or not the post processing of the following main pages is turned ON in Step SA9. When determining that the post processing of the following main pages is turned ON (Step SA9; Yes), the printer control section 110 also turns ON the post processing of the concerned paper sheet (front cover sheet) in Step SA10. When determining that the post processing of the following main pages is turned OFF (Step SA9; No), the printer control section 110 also turns OFF the post processing of the concerned paper sheet (front cover sheet) in Step SA11.

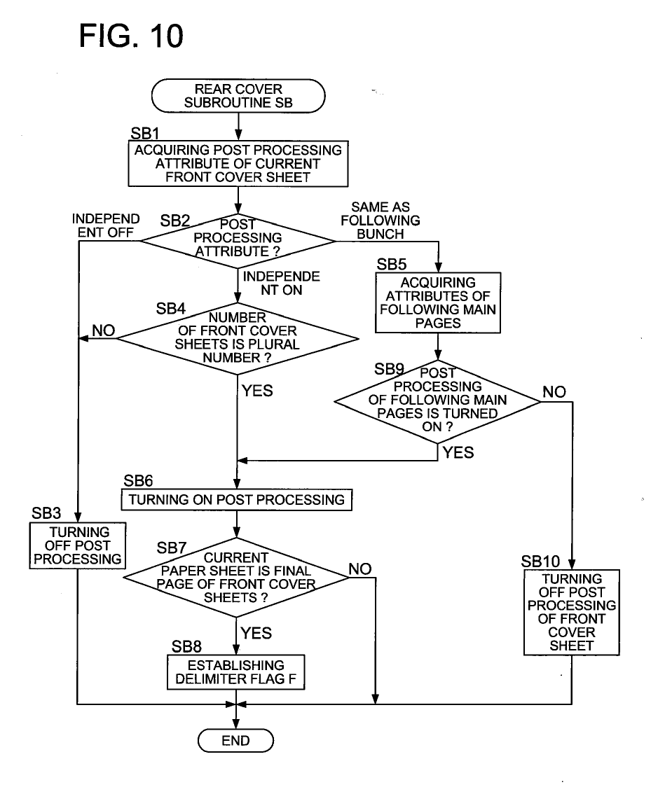

According to the subroutine SB for conducting the post processing determination processing in regard to the rear cover sheet, indicated in the flowchart shown in FIG. 10, initially in Step SB1, the printer control section 110 acquires the post processing attribute of the current rear cover sheet, and then, proceeds to any one of Step SB3, Step SB4 and Step SB5, corresponding to the above-acquired attribute (Step SB2). When the above-acquired attribute indicates “INDEPENDENT OFF”, since no post processing is applied to this paper sheet, the post processing for this paper sheet is turned OFF in Step SB3.

When the above-acquired attribute indicates “INDEPENDENT ON”, the printer control section 110 determines whether or not a number of rear cover sheets is a plural number, from the information of “number of insertion paper sheets” (Step SB4), and when determining that the front cover sheet is a single paper sheet (Step SB4; No), proceeds to Step SB3, so as to turn OFF the post processing. When determining that the number of front cover sheets is a plural number (Step SB4; Yes), the printer control section 110 turns ON the post processing in Step SB6, and in Step SB7, determines whether or not the current paper sheet is the final page of the rear cover sheets. When determining that the current paper sheet is the final page, the printer control section 110 establishes the delimiter information (delimiter flag F) in Step SB8, and then, finalizes the processing (END), while when determining that the current paper sheet is not the final page, finalizes the processing as it is without establishing the delimiter information (END).

When the above-acquired attribute indicates “SAME AS PREVIOUS BUNCH” in Step SB2, the printer control section 110 acquires attributes of the previous main pages in Step SB5, so as to determine whether or not the post processing of the previous main pages is turned ON in Step SB9. When determining that the post processing of the previous main pages is turned ON (Step SB9; Yes), the printer control section 110 proceeds to Step SB6 so as to also turn ON the post processing of the concerned paper sheet (rear cover sheet), and then, conducts the processing of Step SB7 and Step SB8. Since it is necessary for the rear cover sheet to establish the delimiter for the next set, the delimiter information (delimiter flag F) is established in Step SB8. When determining that the post processing of the previous main pages is turned OFF (Step SB9; No), the printer control section 110 also turns OFF the post processing of the concerned paper sheet (rear cover sheet) in Step SB 10.

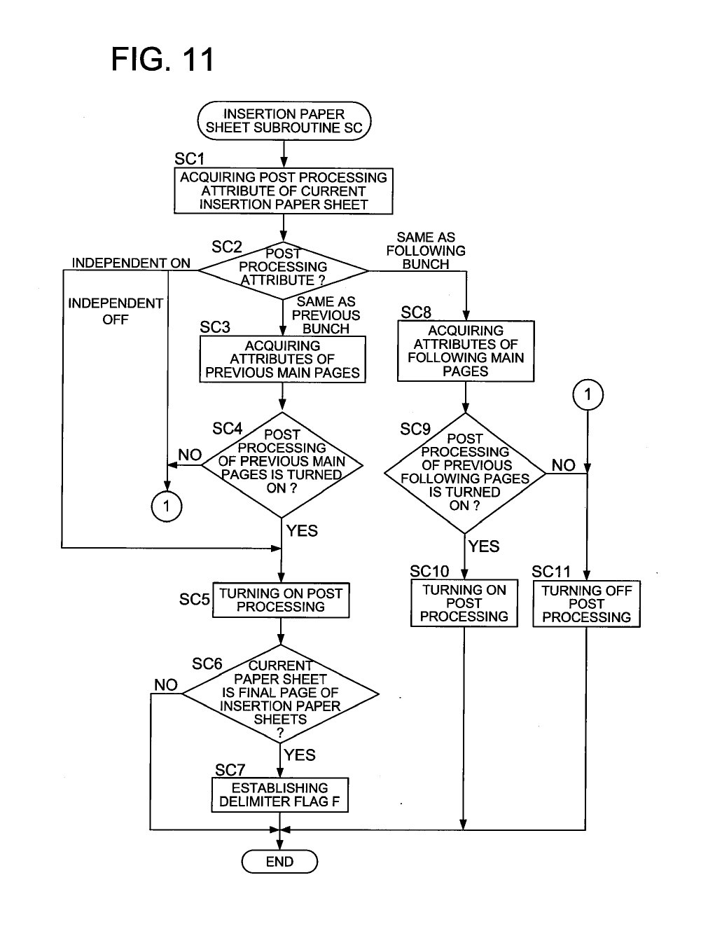

According to the subroutine SC for conducting the post processing determination processing in regard to the insertion paper sheet, indicated in the flowchart shown in FIG. 11, initially in Step SC1, the printer control section 110 acquires the post processing attribute of the insertion paper sheet to discriminate the content of the post processing attribute (Step SC2), and then, proceeds to any one of four branches, corresponding to the content of the above-acquired attribute.

When the above-acquired attribute indicates “SAME AS PREVIOUS BUNCH” in Step SC2, the printer control section 110 acquires attributes of the previous main pages in Step SC3, and when determining that the post processing of the previous main pages is turned ON (Step SC4; Yes), also turns ON the post processing of the concerned paper sheet (insertion paper sheet) (Step SC5). Successively, the printer control section 110 determines whether or not the current paper sheet is the final page of the insertion paper sheets (Step SC6), and when determining that the current paper sheet is the final page, establishes the delimiter information (delimiter flag F) in Step SC7.

When the above-acquired attribute indicates “SAME AS FOLLOWING BUNCH” in Step SC2, the printer control section 110 acquires attributes of the following main pages in Step SC8, so as to determine whether or not the post processing of the following main pages is turned ON (Step SC9). When determining that the post processing of the following main pages is turned ON (Step SC9; Yes), the printer control section 110 also turns ON the post processing of the concerned paper sheet (Step SC10), while When determining that the post processing of the following main pages is turned OFF, also turns OFF the post processing of the concerned paper sheet (Step SC11).

When the above-acquired attribute indicates “INDEPENDENT OFF” in Step SC2, since no post processing is applied to the concerned paper sheet, the printer control section 110 proceeds to Step S11 so as to turn OFF the post processing to be applied to the concerned paper sheet. Further, when determining that the post processing of the previous main pages is turned OFF (Step SC4; No), the printer control section 110 proceeds to Step S11.

When the above-acquired attribute indicates “INDEPENDENT ON” in Step SC2, the printer control section 110 turns ON the post processing in Step SC5, and successively, conducts the processing in Step SC6 and Step SC7.

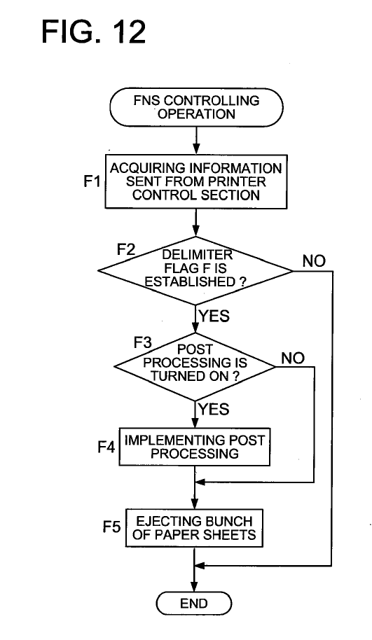

FIG. 12 shows a flowchart indicating a procedure to be conducted in the FNS control section 160 for controlling the post processing on the basis of the information received from the printer control section 110. With respect to this flowchart, the FNS control section 160 conducts the determining and processing operations for every one of the paper sheets.

Initially, in Step F1, the FNS control section 160 acquires the information sent from the printer control section 110 in regard to the current paper sheet. Then, in Step F2, the FNS control section 160 determines whether or not the delimiter flag F is established. When determining that the delimiter flag F is established (Step F2; Yes), since the current paper sheet is the final paper sheet stacked onto the paper sheet stacker 90, the FNS control section 160 further determines whether or not the post processing is turned ON (Step F3). When determining that the post processing is turned ON (Step F3; Yes), the FNS control section 160 implements the post processing in Step F4 and ejects the bunch of paper sheets in Step F5, while when determining that the post processing is turned OFF (Step F3; No), jumps over Step F4 to eject the bunch of paper sheets in Step F5.

When determining that the delimiter flag F is not established (Step F2; No), since the paper sheet is not delimiter of the post processing, the FNS control section 160 finalizes the overall processing of the flowchart without applying no further processing. Accordingly, the concerned paper sheet is stacked onto the paper sheet stacker 90 as it is.

Although the present embodiment described in the foregoing is so constituted that the printer control section 110 determines the contents of the post processing setting information, established in a unit of paper sheet, for every one of the paper sheets so as to send the determined results to the FNS control section 160, it is also applicable that the system is so constituted that the printer control section 110 also conducts the determining operations to be conducted in the FNS control section 160, while the FNS control section 160 controls the implementation of the post processing and transmits the instruction for implementing the ejecting operation.

Further, although, in the present embodiment described in the foregoing, the establishing method, for establishing the various kinds of settings in regard to the post processing from the screen displayed by executing the printer driver and the operating panel, employs the user-friendly items, such as “INDEPENDENT OFF”, “INDEPENDENT ON” and “SAME AS MAIN PAGE”, so as to match it with the user's feeling, it is also applicable that the abovementioned establishment is divided into the selection of whether or not the post processing is “INDEPENDENT” and the other selection of whether the post processing should be ON or OFF.

While the preferred embodiments of the present invention have been described using specific term, such description is for illustrative purpose only, and it is to be understood that changes and variations may be made without departing from the spirit and scope of the appended claims.

What is claimed is:

1. An image forming system that is capable of performing an image forming operation in a post division processing mode, in which one set of main pages constituted by a plurality of paper sheets is divided into a plurality of subsets so as to apply post processing to the plurality of subsets, and an insertion paper-sheet processing mode, in which an insertion paper sheet is inserted into between a pair of main pages located at a predetermined inserting position, the image forming system comprising:
a paper sheet feeding section which feeds a paper sheet;
an image forming section which forms an image onto the paper sheet;
an insertion paper sheet feeding section which feeds an insertion paper sheet;
a post processing section which applies the post processing to a bunch of paper sheets;
an information establishing section which establishes post processing information in regard to the post processing to be applied to a subset; and
a controlling section which controls processing operations to be conducted in the post processing section;
wherein, when both the post division processing mode and the insertion paper-sheet processing mode are established, the information establishing section regards the insertion paper sheet as an independent subset, being independent from the plurality of subsets divided from the main pages, so as to make it possible to establish independent post processing information in regard to the independent subset of the insertion paper sheet; and
wherein, based on the independent post processing information in regard to the independent subset of the insertion paper sheet, the controlling section controls the processing operations to be conducted in the post processing section, so that the plurality of subsets, divided from the main pages, and the independent subset of the insertion paper sheet, being independent from the plurality of subsets, are processed, respectively and separately.

2. The image forming system of claim 1,
wherein the independent post processing information to be established by the information establishing section includes first information representing the predetermined inserting position, second information representing an instruction for making the post processing to be applied to the insertion paper sheet same as that to be applied to a paper sheet just before the insertion paper sheet or same as that to be applied to a following main page, and third information representing an instruction for applying the post processing to the insertion paper sheet regarded as an independent subset or not.

3. The image forming system of claim 1,
wherein the independent post processing information to be established by the information establishing section is inputted from an operating panel of the image forming section or inputted from a screen displayed by executing a printer driver installed in a computer.

4. The image forming system of claim 1,
wherein the post processing includes at least one of a staple processing, a fold processing and a shift processing.

5. The image forming system of claim 1,
wherein, other than the insertion paper sheet to be inserted into between the pair of main pages located at the predetermined inserting position, at least any one of a front cover sheet and a rear cover sheet also serves as another kind of insertion paper sheet.

6. A post processing apparatus that is coupled to an image forming apparatus so as to make it possible to be operated in a post division processing mode, in which one set of main pages constituted by a plurality of paper sheets is divided into a plurality of subsets so as to apply post processing to the plurality of subsets, and an insertion paper-sheet processing mode, in which an insertion paper sheet is inserted into between a pair of main pages located at a predetermined inserting position, the post processing apparatus comprising:
a paper sheet stacker which stacks paper sheets thereon, so as to form a bunch of paper sheets;
a post processing section which applies the post processing to the bunch of paper sheets stacked on the paper sheet stacker; and
a controlling section which controls processing operations to be conducted in the post processing section;
wherein, when both the post division processing mode and the insertion paper-sheet processing mode are established, and when the controlling section receives such post processing information that represents an instruction for regarding the insertion paper sheet as an independent subset, being independent from the plurality of subsets divided from the main pages, and another instruction for applying the post processing to the independent subset of the insertion paper sheet or not, the controlling section controls the processing operations to be conducted in the post processing section, based on the post processing information, so as to collectively stack the paper sheets onto the paper sheet stacker independently from previous and following main pages, and to apply the post processing to the bunch of paper sheets stacked onto the paper sheet stacker.

7. The post processing apparatus of claim 6,
wherein the post processing information includes first information representing the predetermined inserting position, second information representing an instruction for making the post processing to be applied to the insertion paper sheet same as that to be applied to a paper sheet just before the insertion paper sheet or same as that to be applied to a following main page, and third information representing an instruction for applying the post processing to the insertion paper sheet regarded as an independent subset or not.

8. The post processing apparatus of claim 6,
wherein the post processing information is inputted from an operating panel of the image forming section or inputted from a screen displayed by executing a printer driver installed in a computer, and then, transmitted to the post processing apparatus.

9. The post processing apparatus of claim 6,
wherein, when it is established that the insertion paper sheet is not regarded as the independent subset being independent from the previous and following main pages, the controlling section regards the insertion paper sheet same as the previous and following main pages and controls the processing operations to be conducted in the post processing section, so as to stack the insertion paper sheet onto the paper sheet stacker as a same subset of the previous and following main pages, and to apply the post processing same as that to be applied to the main pages.

10. The post processing apparatus of claim 6,
wherein the post processing includes at least one of a staple processing, a fold processing and a shift processing.

11. The post processing apparatus of claim 6,
wherein, other than the insertion paper sheet to be inserted into between the pair of main pages located at the predetermined inserting position, at least any one of a front cover sheet and a rear cover sheet also serves as another kind of insertion paper sheet.

12. The post processing apparatus of claim 6,
wherein the insertion paper sheet is supplied from a paper sheet feeding section of the image forming apparatus.

13. The post processing apparatus of claim 6,
wherein the insertion paper sheet is supplied from an exclusive paper-sheet feeding section, which is provided in the post processing apparatus to be exclusively used for the insertion paper sheet.
